(19) United States
(12) Patent Application Publication
(10) Pub. No.: US 2024/0143910 A1
(43) Pub. Date: May 2, 2024

(54) Video File Integration and Creation System and Method

(71) Applicant: Pro Quick Draw LLC, St. Paul, MN (US)

(72) Inventors: Andrew Erich Bischoff, Hoboken, NJ (US); Troy Bigelow, Fort Mill, SC (US)

(73) Assignee: Pro Quick Draw LLC, St. Paul, MN (US)

(21) Appl. No.: 18/499,722

(22) Filed: Nov. 1, 2023

Related U.S. Application Data
(60) Provisional application No. 63/421,392, filed on Nov. 1, 2022.

(51) Int. Cl. G06F 40/186; G11B 27/031

(52) U.S. Cl. CPC G06F 40/186; G11B 27/031

(57) ABSTRACT

A system and method are presented for creating document pages containing video and data inserted from multiple sources. In one embodiment, a document template uses slots to identify locations for content data. Users select content from a remote server. An identifier for the selected content is used to determine whether a modified version of the content is available. If so, the modified version is inserted into the slot. Otherwise, the remote server content is downloaded and inserted. In other embodiments, an improved user interface allows the selection of events based on groupings of data elements defined for the events. Local files are identified based on a selected event. In yet another embodiment, a video placeholder is used in a document in place of a remote video. The remote video is downloaded temporarily when the document is prepared for presentation.

### FIELD OF THE INVENTION

The present application relates to the field of video file manipulation and modification on a computer system.

### BRIEF DESCRIPTION OF THE DRAWINGS

FIG. 1 is a schematic view of a system for implementing the present invention.

FIG. 2 is a schematic view of data generation used in the system of FIG. 1.

FIG. 3 is a schematic view of the creation of a template-based video document.

FIG. 4 is a schematic view of a template as might be used in FIG. 3.

FIG. 5 is a schematic, high-level view of the generation of a transformed file on a client system.

FIG. 6 is a schematic view of a multiple page template.

FIG. 7 is a user interface presented by a system of the present invention.

FIG. 8 is a selection interfaced used as part of the user interface of FIG. 7.

FIG. 9 is a flow chart showing a process of integrating video sources into a created video file.

FIG. 10 is a user interface presented by a system of the present invention to provide a guided search of client data.

FIG. 11 is a schematic view of a generated integrated video file identifying source locations for portions of the integrated video file.

FIG. 12 is a schematic view showing both a lightweight file containing remote video links and a prepared video file with locally stored video.

FIG. 13 is a flow chart showing a process of creating a lightweight file and a prepared video file, and presenting the prepared video file.

FIG. 14 is a schematic view of a multi-page document.

FIG. 15 is a flow chart showing a method of creating a video playlist from the multi-page document of FIG. 14.

### DETAILED DESCRIPTION

### System 10

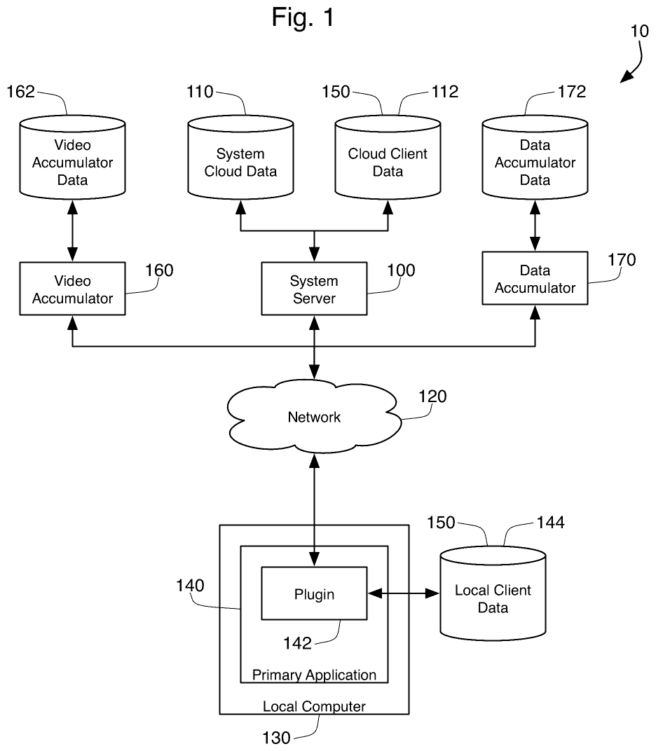

FIG. 1 shows a system 10 for implementing the present invention. The system 10 contains a system server 100 that accesses its own system data 110. Because the system server 100 is accessed through a network 120, the system data 110 is also referred to as system cloud data 110, as other devices will see this data as “cloud data.” The system server 100 may also manage data for its clients, which is shown in FIG. 1 as cloud client data 112. The system server 100 is in communication with a local computer 130 over the network 120. The local computer 130 operates a primary application 140, which is generally a computer program that specializes in creating graphics files or in generating and presenting graphics presentations. For example, the primary application 140 may be Visio or PowerPoint, two separate application programs created by Microsoft Corporation of Redmond, WA. In one embodiment, the primary application 140 is modified by a modification programming, which is described herein as a plugin 142.

The plugin 142 provides additional capabilities to the primary application 140. The term “plugin” generally refers to additional programming designed to operate with a primary application 140 through application programming interfaces (or APIs) included in the primary application 140 for the purpose of supporting such additional programming. In some cases, however, the primary application 140 will not have specialized APIs developed for this purpose. Nonetheless, the additional programming referred to as plugin 142 operates on top of, or in conjunction with, the primary application 140 in order to supplement the capabilities of that programming.

The primary application 140 and its plugin 142 are in communication with locally stored data 144. The locally stored data 144 can be stored on a hard drive or solid-state drive in physical communication with the local computer 130. In many modern systems, local storage is being supplemented by, or replaced by, cloud-based data. In terms of the functioning of the primary application 140, it makes little difference as to whether this data is stored locally or in the cloud. Thus, this data is generally referred to as client data 150. Client data 150 can be stored in the local data 144 or be part of the cloud client data 112. In FIG. 1, the cloud client data 112 is managed by the system server 100, but it is possible for the cloud client data 112 to be managed by another server accessed by the local computer 130 through the network 120.

The system 10 also contains a video accumulator 160, which generally is implemented using its own server accessible over the network 120. The video accumulator 160 has access to video accumulator data 162. The system 10 also contains a data accumulator 170, which is also generally implemented as a server accessible over the network 120. The data accumulator 170 has access to data accumulator data 172.

The system data 110, cloud client data 112, video accumulator data 162, and data accumulator data 172 constitute data stores, meaning that the data is stored on data storage in a manner that allows for easy access and retrieval. In most embodiments, the data is stored as files in a file system or as structured data in the data stores 110, 112, 150, 172. With respect to the local computer 130, all of these data stores 110, 112, 150, 172 can be considered remote data stores as they are accessed by the local computer 130 over network 120.

The system server 100, the video accumulator 160, the data accumulator 170, and the local computer 130 shown in FIG. 1 are all computing devices. A computing device may be a laptop computer, a desktop computer, a higher-end server computer, a tablet computer, or another type of mobile device. These computing devices all include a processor for processing computer programming instructions. In most cases, the processor is a CPU, such as the CPU devices created by Intel Corporation (Santa Clara, CA), Advanced Micro Devices, Inc (Santa Clara, CA), or a RISC processer produced according to the designs of Arm Holdings PLC (Cambridge, England). Furthermore, these computing devices have memory, which generally takes the form of both temporary, random-access memory (RAM) and more permanent storage such a magnetic disk storage, FLASH memory, or another non-transitory (also referred to as permanent) storage medium. The memory and storage (referred to collectively as “memory”) contain both programming instructions and data. In practice, both programming and data will be stored permanently on non-transitory storage devices and transferred into RAM when needed for processing or analysis. As explained above, not all storage is local to the computing devices, as data and programming can be accessed from other devices accessed over the network 120.

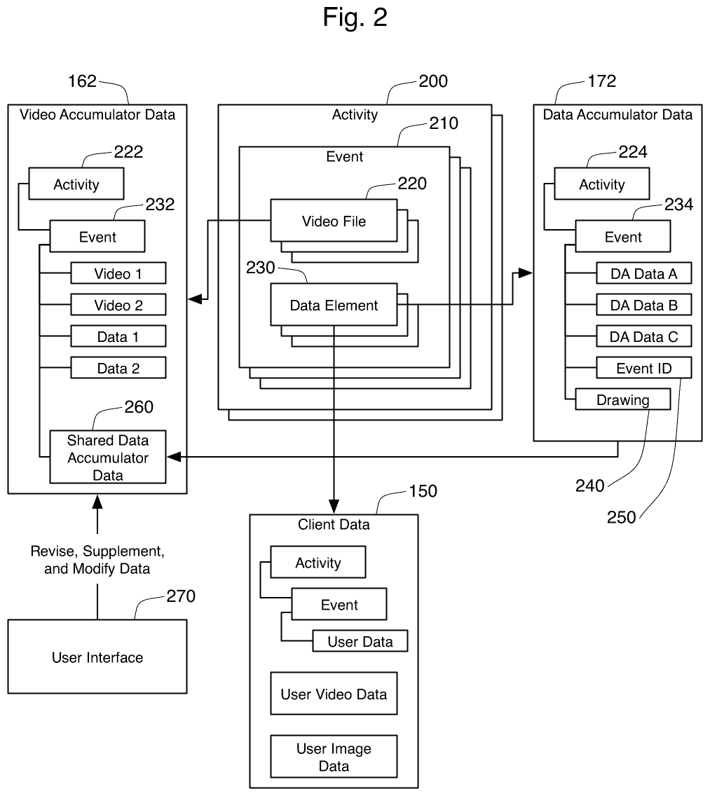

FIG. 2 shows how data is provided to both the video accumulator data 162 and the data accumulator data 172. In one embodiment, the data contained therein is derived from an activity 200 that takes place in the physical world. The activity 200 may be a musical performance, a sporting activity, a job interview, or any other activity 200 that can be divided into multiple events 210. A musical performance can be divided into separate performances, such as separate songs, a theatrical performance can be divided into separate acts, and a job interview into separate questions. For ease in explaining the present invention, the activity 200 will be described as a sporting activity or game, with the separate events 210 comprising separate plays that occur during the game. In some instances, the events 210 can be defined separately than an entire formal play in the sport, such as a serve in tennis (as opposed to the whole tennis point), a face-off in hockey, or a throw-in in soccer.

Each event 210 in the activity 200 can be recorded through multiple video cameras. Each video camera creates a separate video file 220. In addition, data can be recorded about each event, with separate types be data being considered different data elements 230. If the sporting activity is an American football game, the separate video files 220 can be video of a football play taken from different angles, and the data elements 230 might comprise down, yard line, distance to first down, team personnel, formation, current weather conditions, etc. In the context of a sporting event activity 200, the video accumulator 160 is operated by an entity that accumulates video of plays or subsegments of a game for analysis and scouting by coaches. Some examples of sports video accumulators include Dartfish of Fribourg, Switzerland, and the Hudl service provided by Agile Sports Technologies, Inc. of Lincoln, NE. The data accumulator 170 that obtains the data accumulator data 172 can, in some cases, be the same as the video accumulator 160. In other cases, however, the data accumulator 170 is a separate entity. In the context of American football, one of the largest data accumulators 170 is Pro Football Focus (or PFF) of Cincinnati, OH.

The video accumulator 160 may organize the video content it receives from the activity 200 in a hierarchy that maintains information about the activity 200 and the event 210 that was the origin of the video files 220 that it receives. Thus, the video accumulator data 162 may identify the activity 222 and the event 232 from which the video data originated. The activity 222 is effectively the data used by the video accumulator to identify the real-life activity 200, while the the event 232 is likewise the data used by the video accumulator to identify a real-live event 210. The data accumulator data 172 may also maintain this information, also storing an activity 224 and an event 234 with the different data elements 230 that it acquires.

The video accumulator data 162 may include multiple video files 220 (labeled “Video 1” and “Video 2” in FIG. 2) for each event 232 that it tracks. The video accumulator 160 may also store some data elements 230 (“Data 1” and “Data 2”) along with the video files 220 in its video accumulator data 162. Similarly, the data accumulator 170 will track multiple data elements 230 in its data accumulator data 172 (for example, “DA Data A,” “DA Data B,” and “DA Data C” in FIG. 2) for each event 234 that it tracks. The data accumulator 170 is generally separate from the video accumulator 160 because the data accumulator 170 is generally more capable of advanced data analysis than the video accumulator 160. In some embodiments, the data accumulator 170 is capable of analyzing the data elements 230 it receives and then generating a visual representation or drawing 240 of those data elements 230. Furthermore, the data accumulator 170 may assign an event identifier 250 to the particular event 234 that it tracks in its data accumulator data 172. In some cases, the event identifier 250 assigned by the data accumulator 170 becomes the preferred identifier for that real-life event 210 for all participants in the system 10.

FIG. 2 also shows that, in some instances, the data accumulator 170 will send some of its data as shared data accumulator data 260 to the video accumulator 160, which will then save this shared data accumulator data 260 in its video accumulator data 162. This integration allows a user to access the video accumulator data 162 through a user interface 270 and still have access to data maintained and analyzed by the data accumulator 170. With this user interface 270, the user can revise, supplement, and modify the video accumulator data 162 to better serve the needs of the user.

In some embodiments, the user will also store data concerning the activity 200 in their client data 150. This data may also be divided by activity 200 and event 210, and may contain the same or similar video files 220 and data elements 230 that are stored in the video accumulator data 162 and the data accumulator data 172. Alternatively, different data, video, and image files might be stored in the client data 150.

### Document Generation

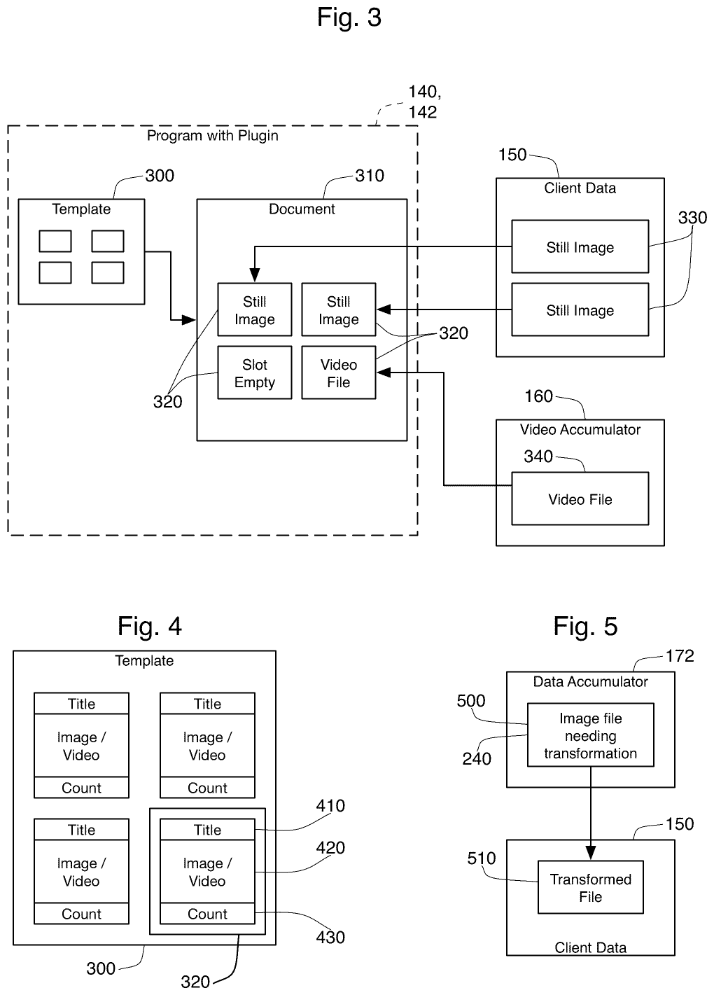

FIG. 3 shows how a primary application 140 (working with plugin 142) can utilize a template 300 in order to generate a document 310. The template 300 defines a plurality of slots 320 in the document 310. In other words, a template 300 defines one or more slots 320 (template slots) to identify where content items can be placed in the document. A new document 310 (or a new page in the document 310) is created using that template 300, and the template slots are used to define where slots 320 will appear in the document. The user can select still images 330 from their client data 150 for insertion into the slots 320 of the document 310. The utilization of a template 300 to define slots 320 in a document 310, and then insert content items (such as still images 330) into the slots 320 through selection from client data 150 is partially described in a related patent application, namely U.S. application Ser. No. 17/148,869, filed on Jan. 14, 2021, which is hereby incorporated by reference in its entirety.

As shown in FIG. 4, each template 300 can subdivide each slot 320 into separate components, such as a title component 410, a visual component 420 that might contain a still image or a video component, and a count component 430. These separate components 410, 420, 430 can constitute “boxes” that are grouped together into a box set that comprises the slot 320, as partially described in a related patent application, namely U.S. application Ser. No. 17/723,294, filed on Apr. 18, 2022, which is also hereby incorporated by reference in its entirety.

One of the still images 330 in the client data 150 shown in FIG. 3 might comprise a transformed file 510 that is derived from an image file needing transformation 500 created by a different source, such as the data accumulator 170. This is shown in FIG. 5. In some embodiments, the image file needing transformation 500 may comprise the drawing 240 created by the data accumulator 170 from the data elements 230 received about an event 210. U.S. application Ser. No. 17/702,897, filed on Mar. 24, 2022, (hereby incorporated by reference in its entirety) describes various processes for transforming an image file, and one or more of the process from this incorporated reference could be used to generate the transformed file 510.

Returning to FIG. 3, in some embodiments one of the slots 320 in the document 310 can contain a video file 340 that is obtained from the video accumulator 160. Thus, a single document 310 has slots 320 containing still images 330 from the client data 150 (one of which may be a transformed file 510) and at least one slot 320 containing a video file 340 obtained from the video accumulator 160. Each of these slots 320 may be defined in a template 300 according to separate fields or data boxes, such as shown in FIG. 4.

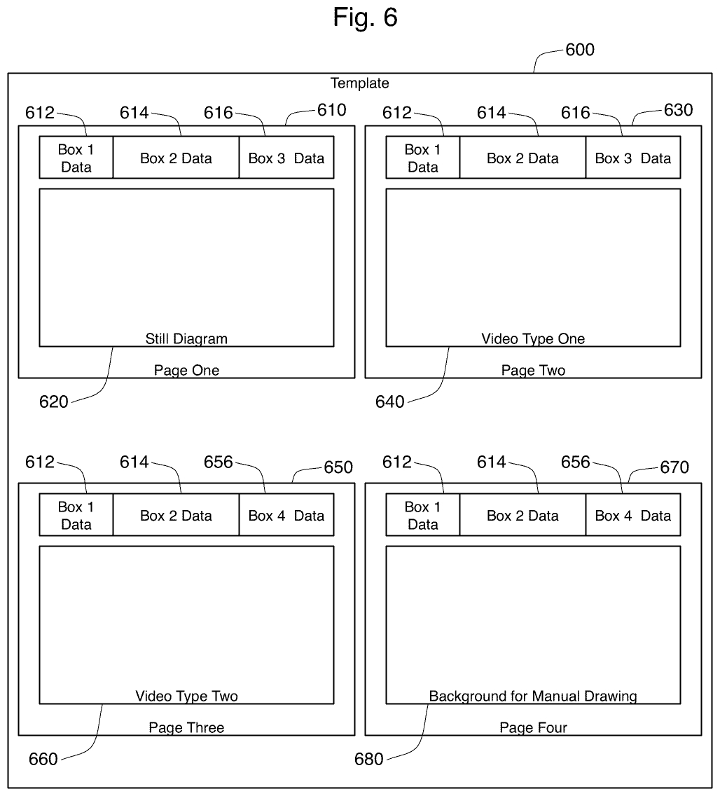

FIG. 6 shows a new template 600 that defines four separate pages 610, 630, 650, 670 for a document. Each of these pages 610, 630, 650, 670 are similar, but contain slightly different components. The first page 610 contains data boxes for particular fields of data, name box 1 data 612, box 2 data 614, and box 3 data 616. These different fields of data 612, 614, 616 represent data of a particular type that might be extracted from a data source. This data might be the data elements 230 obtained from an event 210 and stored in the data accumulator data 172 or in the shared data accumulator data 260 maintained by the video accumulator 160. In the context of an American football activity, data 612 might be the “down” of an event 210, data 614 might be the “distance to first down” and data 616 might be the “formation.” The first page 610 also defines a still diagram or image box 620, which can contain a still image that is stored in the client data 150, the video accumulator data 162, or the data accumulator data 172.

The second page 630 is similar, in that it contains the same three fields of data 612, 614, 616. It differs from the first page 610, however, in that it contains a data box 640 for video of “type one.” The video may be stored by, and be accessed through, the video accumulator 160. The “type” of video may represent a video source designation (such as a camera angle) that identifies one of the video files 220 acquired during an event 210 and accumulated by the video accumulator 160.

The third page 650 contains two fields of data 612, 614 in common with the first page 610 and the second page 630. Rather than field of box 3 data 616, however, the third page 650 contains box 4 data 656. In the context of an American football activity 200, this might represent a “field location” data element 230. The video element box 660 of the third page 650 is of a different type than the video element box 640 of the second page 630. In other words, the third page 650 contains video with a different video source designation than the second page 630.

The fourth page 670 contains the same data fields 612, 614, 656 as the third page 650. Rather than containing a video element box 660, the fourth page 670 contains a background image 680. This background image 680 is made available for a user to manually add objects upon using a graphical editor within the primary application 140 and/or the plugin 142.

As explained above, template 600 is used by the primary application 140 (perhaps with the plugin 142) to create new documents, or new pages in an existing document. In the context of slots 320 of FIG. 4, this template 600 could be considered to have four slots 320, each of which defines a separate page 610, 630, 650, 670. A single slot 320, such as the slot that defines page one 610, can have multiple template data boxes 612, 614, 616, which will be used to define data locations in the resulting document. The template image box 620 is used to define a location for a content item in that document. The various boxes 620, 640, 660, 680 that are designed for visual data such as drawings, diagrams, images, and video can be referred to as content boxes. Template content boxes 620, 640, 660, 680 therefore define location where visual data will be inserted into the resulting document.

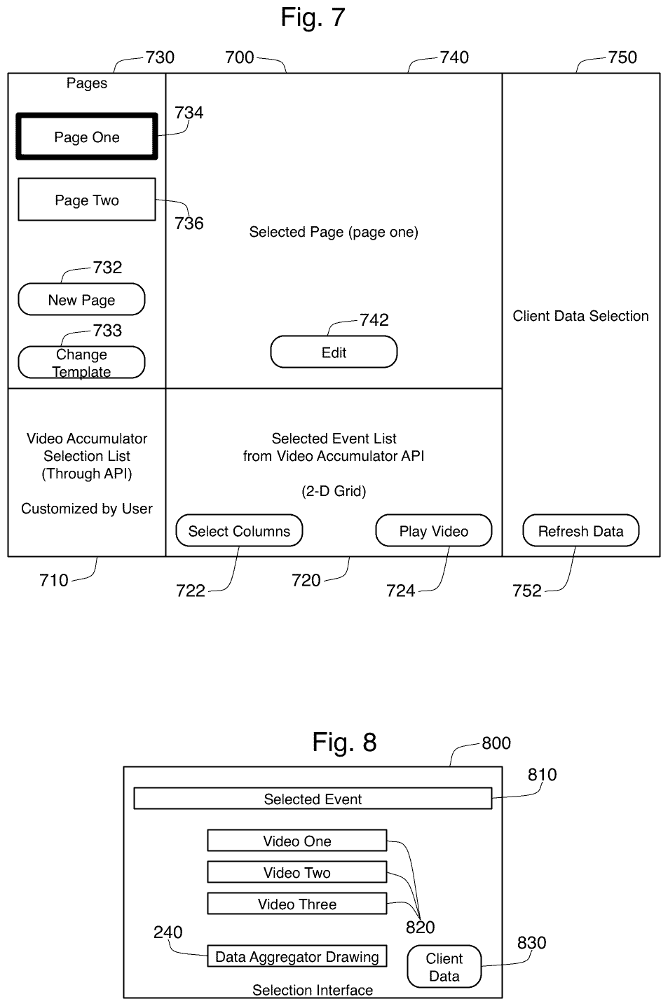

In one embodiment, the template 600 is utilized through a graphical user interface, such as interface 700 shown in FIG. 7. This interface 700 is created by the primary application 140. More particularly, in one embodiment, the interface 700 is provided by the plugin 142 operating within or in conjunction with the primary application 140. In this embodiment, the primary application 140 is a general-purpose drawing program such as Visio or a general-purpose presentation program such as PowerPoint. For ease in discussion, some of the following descriptions will suppose the primary application 140 is a presentation program. The plugin 142 operates with the primary application 140 to provide user interfaces such as interface 700. The plugin 142 also provides access to the templates, such as template 300 or template 600, and utilizes these templates to create documents such as document 310.

The interface 700 is provided with a variety of sections or segments that contain different information and interface elements. Starting at the lower left, the video accumulator interface segment 710 provides access to materials stored by the video accumulator 160. In some embodiments, the plugin 142 utilizes an application programming interface (or API) to request data from the video accumulator 160 and to present this data in the video accumulator interface segment 710. The information stored in the video accumulator data 162 of the video accumulator 160 can be modified, updated, and clarified using the user interface 270 described above. Thus, it is this potentially-modified video accumulator data 162 that is presented in video accumulator interface segment 710. The organization of the data shown in video accumulator interface segment 710 is not restricted to the activity 222 and event 232 hierarchy shown in FIG. 2. Rather, data stored about each event 232 can be utilized to group these events 232 as might be desired by the user. For example, events 232 can be grouped together by one or more of the data elements 230, and the video accumulator interface segment 710 then presents these groupings of events 232 to the user for user selection. For instance, in the context of American football, one grouping of events might be “third down, 8+ yards to go, in the red zone” events. The user could select this grouping of events from the video accumulator interface segment 710 so that they can be shown particular events 232 that are part of this grouping.

The second segment in interface 700 is the selected event list segment 720, which provides a listing of all of the events 232 stored by the video accumulator 160 that belong to the selected groupings in the video accumulator interface segment 710. These events 232 are presented as data elements from the video accumulator data 162 that identify (and are derived from) the actual events 210 that took place during the activities 200. Because the events 232 may be grouped in a variety of different ways in the video accumulator interface segment 710, the events 232 listed in the selected event list segment 720 may have originated from multiple, different activities 200.

Each of these listed events 232 may be associated with different data elements 230 that are maintained in the video accumulator data 162. In some instances, a single event 232 may be associated with dozens of different data elements 230. Consequently, the selected event list segment 720 provides a button 722 (or other interface element) that provides an interface through which a user may selected a subset of available data elements 230 to be displayed in the selected event list segment 720. The interface accessed through this button 722 may also identify a method for sorting or otherwise arranging and grouping the listed events 232 in the selected event list segment 720. This interface might also allow the user to further filter the listing of events 232 such that not all of the events 232 selected through the video accumulator interface segment 710 are displayed in the selected event list segment 720. These options allow this segment 720 to present the events 232 in a manner desired by the user.

The user is able to select one of the events 232 listed in the selected event list segment 720. These events 232 are tracked by the video accumulator 160 as being associated with one or more video files 220 obtained during the actual event 210. Thus, after selecting one event 232, the user can select button 724 (or other interface element) to retrieve a selection interface 800, shown in FIG. 8. This interface 800 identifies the selected event at interface element 810, and then presents a list 820 of available video files for that selected event. By selecting one of the events in the list 820, the user will cause the plugin 142 to use the API of the video accumulator 160 to cause the selected video to play. After the video is played, the user returns to interface 700.

After the user selects an event 232 in the selected event list segment 720, the user can press the new page button 732 in the page list segment 730 of interface 700. Upon selection of the new page button 732, the user may be asked to select a template 300 for the new page. The template 300 may be a multi-page template such as template 600 or may be a template 300 for only a single page. In interface 700, the user can also manually change the current template by selecting interface element 733. In the preferred embodiment, the template will include one or more fields of data (such as fields 612, 614, 616, 656) as data boxes and at least one video or image box (such as image boxes 620 680, and video boxes 640, 660). In some cases, the template might identify a particular video type for the new page, such as a video source designation that selects the desired camera angle for that page. If so, once the template 300 is selected, a new page is created in the document 310 according to that selected template 300. In other cases, the template 300 identifies the fields of data, but not the type of video file. In this case, the selection interface 800 may be presented to allow the user to select a particular video file desired for the new page. Once selected, the appropriate video file 220 for the selected events 232 will be used to create the new page based on the template 300.

In some embodiments, the selection interface 800 also includes the ability to select file types that are not video files 220 stored by the video accumulator 160. For example, selection interface 800 also includes the ability to select the drawing 240 created by the data accumulator 170. As explained above, this drawing 240 is based on the analysis of data elements 230. If this is selected, the drawing 240 for the selected event is identified in the data accumulator data 172, downloaded, and used to create the new page.

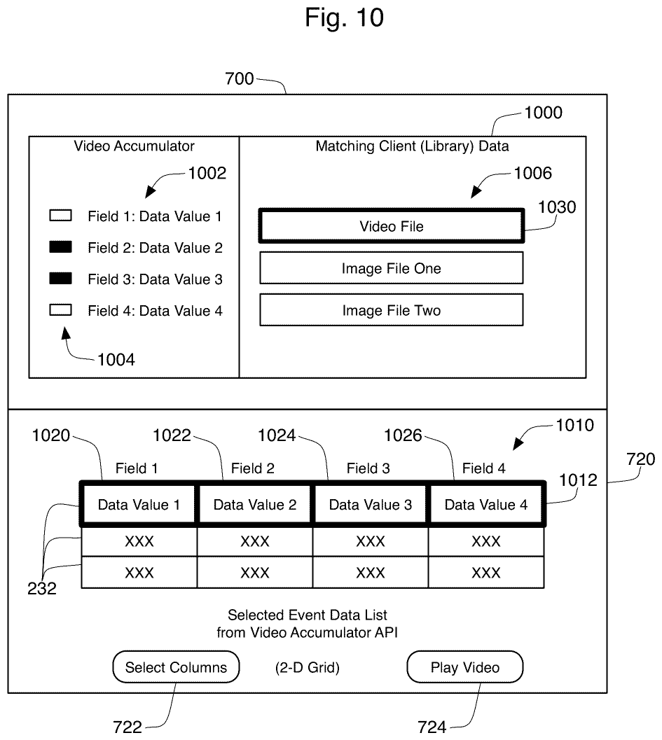

As explained above, the drawing 240 created by the data accumulator 170 may need to be transformed into a transformed file 510. In some embodiments, this transformation is performed whenever the drawing 240 is selected in the selection interface 800, and it is this transformed file 510 that is used to generate the new page. The transformed file is then stored in the client data 150 so that it does not need to be re-transformed every time it is desired by a user. The selection interface 800 also includes a button 830 to select a file to an event from client data 150, which is described below in connection with FIG. 10.

Obviously, it may not be necessary for the user to select a template 300 after each press of the new page button 732, as a default template 300 may be used. Furthermore, it is not necessary that the new page contain a video file, as a background image as used in box 680 or a still diagram as used in box 620 can be selected as well.

The page list segment 730 also contains a list of pages in the current document, with FIG. 7 showing a first page 734 and a second page 736 in the page list segment 730. A user can select one of the listed pages, with the first page 734 being selected in FIG. 7 (as shown by the bold outline in that figure). The selected page is then presented to the user in the selected page segment 740 of the interface 700.

The user is allowed to edit the presented page in the selected page segment 740 using the standard editing functions of the primary application 140. In some instances, the plugin 142 may supplement the editing functions provided by the primary application 140 with additional editing features. In some embodiments, whatever page is presented in the selected page segment 740 is immediately editable. In other embodiments, an edit button 742 (or other element) must be selected by the user before editing is allowed. These other embodiments may even open a separate editing window to edit the page.

The user may edit the data fields 612, 614, 616, 656 inserted into a page by the template. In addition, the user may make changes to the video files 220 or still images (such as the drawing 240 or even the transformed file 510) that have been inserted into the page. These changes are then stored in the client data 150 as separate files so that they may be reused. An association is maintained by the system 10 (in the plugin 142 and its associated programming) between the original data files found on the video accumulator data 162 and the data accumulator data 172, and the files that contain edited versions of those original data files. In this way, it is possible for the plugin 142 to acquire the preferred, edited version of a file whenever the user selects the original file through the selection interface 800.

Note that the above description implied that the selected template 300 creates only a single page after the new page button 732 is selected. Template 600 defines four separate pages. If this template 600 were selected, four different pages will be created as defined by the template 600 (as is explained above). There would be no need to present the selection interface 800 as the types of video to be inserted for the selected event 232 would be determined by the template 600 itself. After the template 600 is used to create new pages, all four pages would be presented in the page list segment 730, although in some embodiments only a single page would be selected and shown in the selected page segment 740 for viewing and editing.

The client data selection segment 750 is effectively another data source from which new pages can be created. The client data selection segment 750 presents the data found in the client data 150, whether stored in the local client data 144 or the cloud client data 112. The client data 150 may contain images, video files, or drawings. In the context of athletic activities 200, the system 10 may be used by coaches to examine their own and their competition's plays and strategies. A coach may have their own play diagrams that they have manually created and stored in their client data 150. The client data selection segment 750 allows the user to view this type of data, and the select that data for use in the creation of a new page in the document. When a file is selected in client data selection segment 750, the new page button 732 can be selected and a new page based on the selected template 300 and the selected file will be created.

As explained above, the client data 150 contains originally created files such as a coach's play diagram, as well as edited versions of files and diagrams originally retrieved from video accumulator data 162 and data accumulator data 172. The system 10 is designed to substitute edited version of the original data files when selected by the user. If the user wishes to eliminate all edited version of original files, so that only the original files are used, the user can select the refresh data button 752. This button 752 can operate on a single file that might be selected through the client data selection segment 750, on all drawings created by the data accumulator 170, or on all edited files that were based on originals in either the video accumulator data 162 or the data accumulator data 172.

Method for Creating Video Files Integrated from Multiple Sources

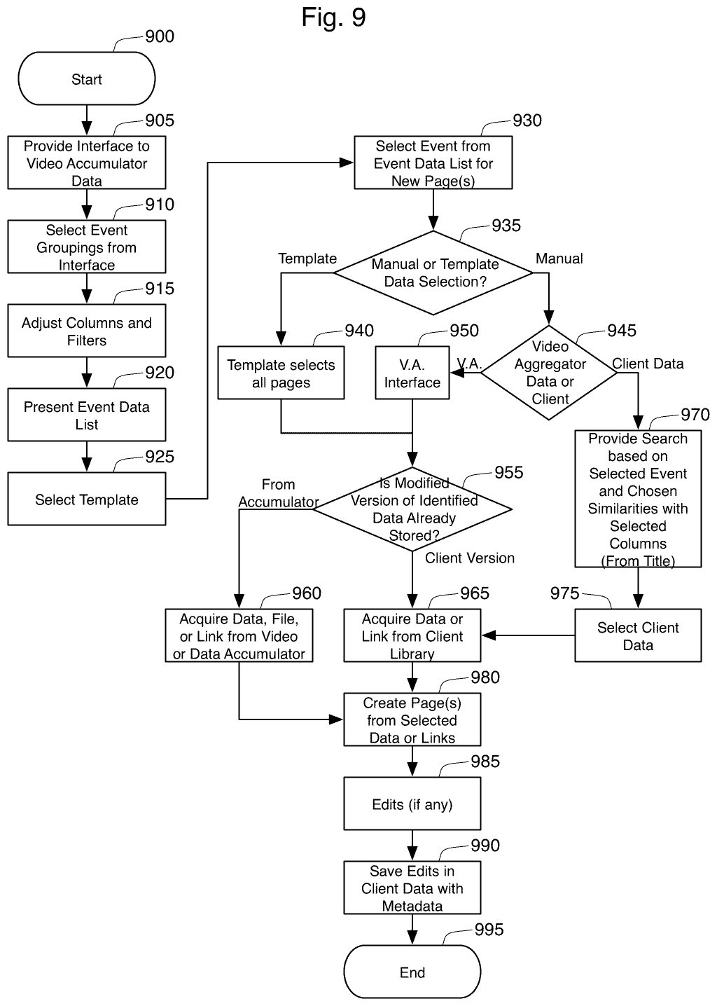

FIG. 9 contains a flowchart describing a method 900 for creating video files. While this method 900 is described using the interface 700, it is not necessary to use the exact interface shown in FIG. 7 to perform method 900. Likewise, the interface 700 need not utilize the exact steps of method 900.

Method 900 begins with step 905, in which a user interface, such as interface 700 is presented to the user. This interface includes access to the video accumulator data 162, such as through video accumulator interface segment 710. Using this video accumulator interface segment 710, the user can select particular event groupings at step 910. The relevant events 232 based on the selected grouping(s) will then be shown, such as are shown in the selected event list segment 720. Of course, the user is able to adjust the columns, and determine sort and filter criteria for those displayed events 232, which is shown at step 915. This is described above in connection with the interface accessed through button 722. At step 920, the list of events 232 for selection is presented through the user interface. The listed events 232 are based on the selected groupings from step 910, and are presented based on the columns, sorting, and filtering criteria from step 915.

Step 925 selects a template 300 for the generation of a new page. This can be done manually by a user (such as through interface element 733). It can be done page-by-page, or the previously used template can be used by default. Alternatively, a user can select a default template through a preferences setting. In other embodiments, the template 300 is selected automatically by the system 10. In still other embodiments, only a single template is available.

Next, step 930 has the user select one of the events from the event data list created at step 930 for the creation of one or more new pages. Step 935 begins the selection of data for insertion into the new page. It may be that the template 300 will define which data element should be used for the new page. For example, the template 300 may define three slots 320, with each slot 320 designated for video data from one of three different camera angles for the same event 232. If it is the case that the template 300 determines the content item to be inserted for an event 232, this is determined by step 935 and the template will then select the content items and data elements for the new page (or the new pages) at step 940. If step 935 indicates that the user should manually select the content item(s), then an appropriate interface will be presented. First, however, step 945 determines whether the user is currently interacting with the video accumulator interface (through the selected event list segment 720) or through a client data interface (the client data selection segment 750). If the user made the selection of an event through the selected event list segment 720, then an appropriate selection interface 800 will be provided at step 950.

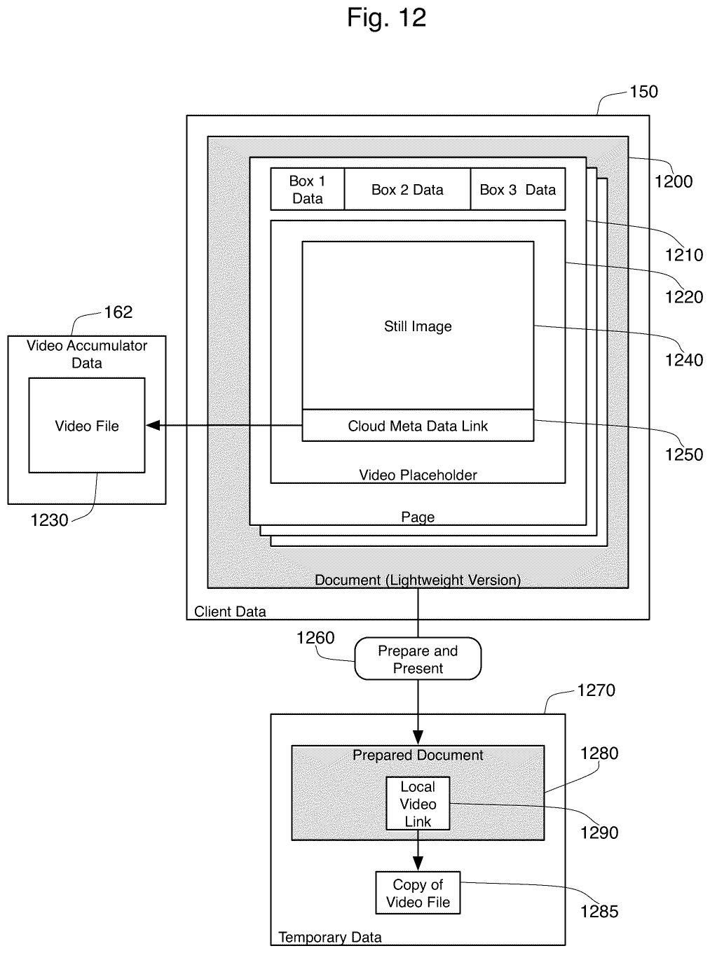

Step 955 is performed when either the template selects the content for the new page(s) (step 940) or the selection interface 800 selects the content (step 950). Step 955 is necessary to identify situations where data is being requested from the video accumulator data 162 or the data accumulator data 172, but suitable or better data is already found in the client data 150. It may be that the data found in the client data 150 is identical to the data stored in the video accumulator data 162 or in the data accumulator data 172, but it would still be preferable to access the local data to reduce data traffic and speed up performance. More importantly, if a user has modified the data found on the video accumulator data 162 or the data accumulator data 172, it is up to step 955 to identify this and acquire the preferred edited data. As explained in more detail below, this identification is performed by ascertaining a metadata identifier for the requested data and then searching for copies of, or modified versions of, that data in the client data 150 using that identifier. If step 955 confirms that relevant data is not already found on the client data 150, then step 960 will acquire the data from the appropriate data source (video accumulator data 162 or data accumulator data 172). If the preferred source is the client data 150, then step 965 will acquire the data from that source. In one embodiment described below in connection with FIG. 12, the actual data is not downloaded at this time—only a link to the data is identified and used for page creation.

Returning to step 945, if the user is to select a file for inclusion in a page directly from the client data listing (from client data selection segment 750), step 970 provides a search interface for the selection of that data. In the preferred embodiment, the user may still have selected an event at step 930 before requesting data from the client data 150. Thus, the interface from step 970 will use this selection to help identify the appropriate data. An example of such an interface is interface 1000 is shown in FIG. 10 and described below. From this interface 1000, the user will select the client data at step 975, and the method continues at step 965.

At step 980, the data acquired from step 960 or step 965 is used to generate one or more pages (as may be determined from the template identified at step 925). The created pages can be listed through a page list segment 730, and a selected page can then be presented through a selected page segment 740. The created page can be based upon a template 300, with the data acquired from step 960 or step 965 comprising the content item for the slots 320 defined by the template 300. At step 985, the user is allowed to edit the created page. As explained above, this editing may include editing of the data acquired at step 960 or 965. If edits are made to this data, step 990 will store the edited version of this data in client data 150.

This data can be stored in association with metadata describing aspects of the data. This metadata may include an identifier for, or a description of, the original file so that a link between the edited file and the original data can be identified at step 955. For instance, an event identifier 250 established by the data accumulator 170 can become the default identifier for all files associated with a particular event 210 that are stored in the client data 150. Thus, this event identifier 250 can be used to access different video files 220 in the video accumulator data 162 for that event 210, can be used to access many different data elements 230 gathered and maintained by the data accumulator 170 for that event 210, and can be used to access new or edited files in the client data 150 for that event 210.

In some embodiments, unedited versions of the data retrieved at step 960 are also stored at step 990 so that duplicate retrievals of the same data need not be made. At this point, the file with embedded content, including video content, has been created and can be saved in the client data 150 along with the edited version of content. The method 900 then ends at step 995.

FIG. 10 shows a pop-up search interface 1000 that appears on top of interface 700 at step 970. This interface 1000 assists a user who is searching for relevant data on client data 150. FIG. 10 shows only a portion of interface 700, namely selected event list segment 720. Selected event list segment 720 shows a list 1010 of events 232 in the video accumulator data 162 that comply with the selections made by the user through video accumulator interface segment 710 (not shown in FIG. 10). For example, if the activity 200 related to an American football game, and the event 210 were individual plays, the video accumulator interface segment 710 could be utilized by a coach to identify plays (events 232) made by an upcoming opponent on 3^{rd} down and long situations. The events 232 that are consistent with that selection in video accumulator interface segment 710 are then presented in list 1010 in selected event list segment 720. The list 1010 contains particular columns that could be selected by the user through button 722. In this case, the columns include “Field 1,” “Field 2,” “Field 3,” and “Field 4.”

The user selects one of the events 232 in the list 1010 as the selected event 1012 (shown in FIG. 10 through a bolded outline). When the user elects to create a new page based on this selection, the user may be presented with the selection interface 800. One option on that interface is the client data button 830. If selected, this indicates that the user wishes to select a file for insertion into the new page from the client data 150. In this case, the search interface 1000 will be displayed.

The interface 1000 identifies the displayed fields from selected event list segment 720, determines the values of those displayed fields in the selected event 1012, and then presents this information in list 1002. The list 1002 displays a name for all of the displayed columns (field 1, field 2, field 3, and field 4) and the values in that column for the selected event 1012. In particular, the list 1002 shows field 1 being assigned Data Value One 1020, field 2 being assigned Data Value Two 1022, field 3 being assigned Data Value Three 1024, and field 4 being assigned Data Value Four 1026. Next to each item on this list 1002 is a checkbox 1004. The user is able to select a subset of the fields on the list 1002 for searching the client data 150. In this case, the user has selected field 2 (with a value in the selected event 1012 of Data Value Two 1022) and field 3 (with a value in the selected event 1012 of Data Value Three 1024), as indicated in FIG. 10 by the filled in checkboxes 1004. In other words, the list 1002 is a larger list than that which is actually utilized to find an appropriate data file, being based on all of the displayed columns. The user is then able to create a subset of this larger list of data elements through the checkboxes 1004. This subset is then used to find a data file.

When the selections of the checkboxes 1004 are made, a list 1006 of files on the client data 150 are shown next to it in the pop-up search interface 1000. The files in list 1006 are those files in the client data 150 that match the selected fields and values from list 1002 as limited by the selected checkboxes 1004. In one embodiment, the system 10 (typically in the form of programming in the plugin 142) searches the files in the client data 150 that match the selections in list 1002. The match can be made in metadata maintained by the system 10 about the files in the client data 150. In other embodiments, the metadata is maintained in the files themselves. In yet another embodiment, the searching performed to create the list 1006 is performed only on the file names of the files in the client data 150. In this last embodiment, care must be taken when naming the files in the client data 150 so that the file names will contain enough information to match the data values from the selected fields in list 1002. Once the list 1006 of matching files is created, a user can select one of the files in the list 1006. In FIG. 10, Video file 1030 is selected. This selection accomplishes step 975, and the method 900 continues at step 965.

As explained above, the list 1010 shown in FIG. 10 contains a list of those events 232 in the video accumulator data 162 that comply with the selections made by the user through video accumulator interface segment 710. made by the user through video accumulator interface segment 710. Thus, even if no checkboxes 1004 are selected, the list 1006 shown in interface 1000 need not show all of the files in the client data 150, but only that data the conforms to the selection made by the user through video accumulator interface segment 710. Note that this ability to search the files in the client data 150 based on the selections in the selected event list segment 720 is not required to find and select client data 150, as the client data selection segment 750 can be used independently to examine all of this client data 150. The interface used to examine the data in client data selection segment 750 can be based on standard folder hierarchies typically used for storing files in a file system.

### Created Page 1100

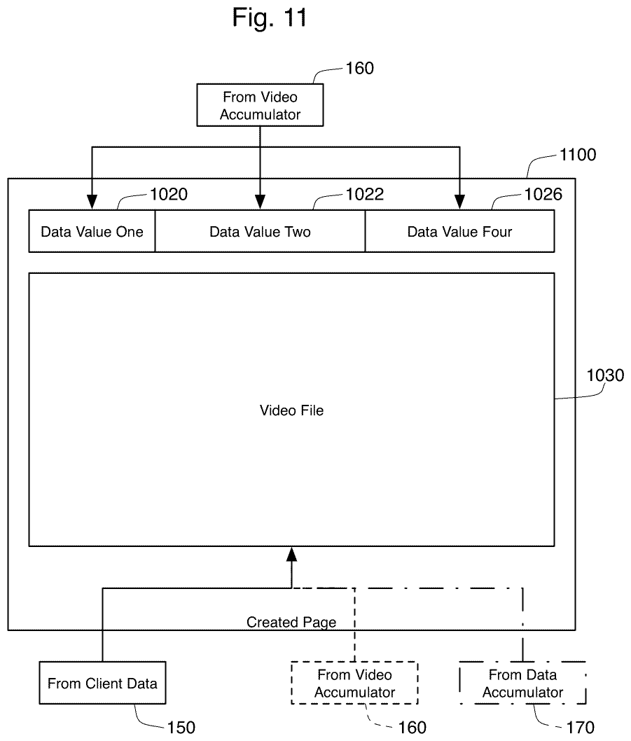

FIG. 11 is a schematic view of a created page 1100 created at step 980 in method 900. This page 1100 can be a single page in a multipage document 310, or the only page 1100 in that document 310. In this page 1100, it can be seen that the template 300 defined three types of data to appear at the top of the page 1100. When the page 1100 was created, data for the selected event was placed into the page 1100, with the appropriate information being placed into appropriate spots of the page 1100. If the interface 1000 of FIG. 10 was used for this page 1100, the data is taken from the selected event 1012. In particular, Data Value One 1020, Data Value Two 1022, and Data Value Four 1026 have been taken from the data for the selected event 1012 stored in the video accumulator data 162 and then inserted into the page 1100. Some of this video accumulator data 162 may be part of the shared data accumulator data 260, and hence may have first been created by the data accumulator 170. Furthermore, the video accumulator data 162 may have been modified through the user interface 270 into a format and language desired by the user. In other cases, some or all of the data inserted into the page 1100 may have come from the data accumulator data 172. FIG. 11 shows that this data 1020, 1022, 1024 was extracted from the video accumulator 160.

Similarly, the template 300 identifies a location for an image or video file, and step 980 inserts a selected item, such as video file 1030, into the page 1100 at that location. In this case, the video file 1030 came from the client data 150 through the selection interface 1000. This sourcing of the video file 1030 is shown in FIG. 11 by the inclusion of the client data 150 element and the solid line arrow pointing to video file 1030. In other pages, the video or image file inserted into the page 1100 may come directly from the video accumulator data 162 of the video accumulator 160 or the data accumulator data 172 of the data accumulator 170.

Thus, the created page 1100 contains data 1020, 1022, 1026 that was automatically extracted from the video accumulator data 162 and a video file 1030 from client data 150. This video file 1030 was, in turn, identified by finding common characteristics with the selected event 1012 in interface 1000. This automatic insertion of data and image or data files from a plurality of sources into a single page of a document is one of the unique aspects of the present invention.

### Lightweight and Prepared Video Pages

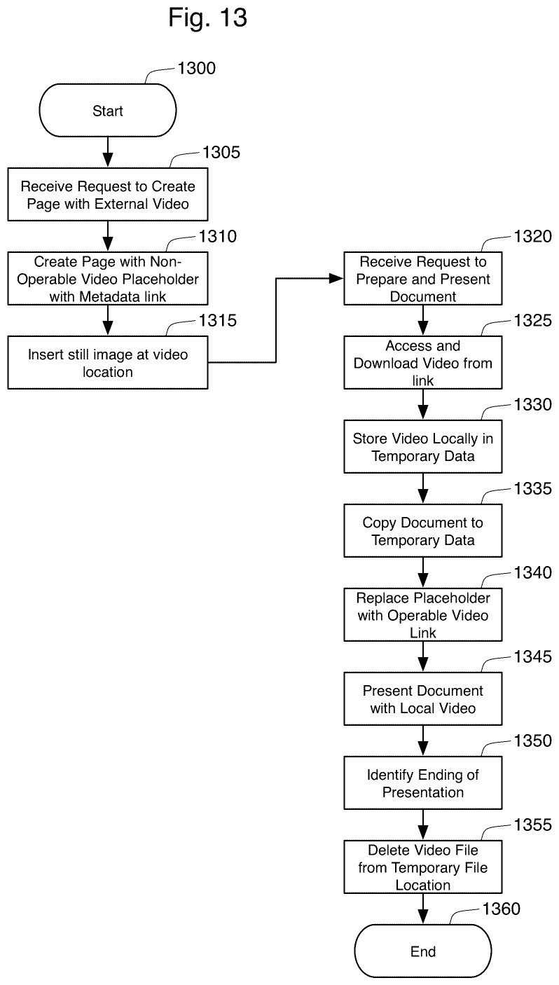

FIG. 12 is a schematic drawing showing the various elements used to create a lightweight document 1200 and a prepared document 1280 using the method 1300 shown in FIG. 13. FIG. 12 shows client data 150 and video accumulator data 162. In addition, FIG. 12 shows temporary data 1270. Temporary data 1270 is data that can be local to the local computer 130 or stored in the cloud, such as part of the locally stored data 144 or the cloud client data 112. In other words, temporary data 1270 may not be physically distinguishable from other client data 150. The difference with the temporary data 1270 is that it is not designed to be permanent. Information in the temporary data 1270 can be used, and will persist while it is needed, but will be erased when no longer needed.

The method 1300 starts with step 1305, which receives an insertion request to insert a remote video into a page in a document. In this case, the document is lightweight document 1200 stored in the client data 150, and the remote video is video file 1230 stored at a remote location accessible over the network 120, such as in the video accumulator data 162. The page 1210 in the lightweight document 1200 is created at step 1310. The creation of the page 1210 is accomplished using the primary application 140 (using plugin 142), as the lightweight document 1200 is a document of the type created by the primary application 140. For example, the primary application 140 might be PowerPoint, meaning that the lightweight document 1200 is a PowerPoint document. In PowerPoint documents, separate pages are considered “slides,” thus the new page 1210 would be a new slide created by the PowerPoint primary application 140.

Rather than downloading the video file 1230 and inserting it into the new page 1210, step 1310 creates a video placeholder 1220 in the page 1210. At step 1315, a still image 1240 is used as part of the video placeholder 1220. This still image 1240 is preferably extracted or otherwise taken from the video file 1230. For example, the still image 1240 might be the first frame of the video file 1230, or the middle frame of the video file 1230. The video placeholder 1220 also consists of metadata, in particular a cloud metadata link 1250 to the video file 1230. The cloud metadata link 1250 is simply a link that identifies the location of the video file 1230 in a sufficient matter so to allow it to be accessed and downloaded at a later time. Note, in some embodiments the still image 1240 is not taken from the video file 1230, but is another indicator that the video will be available when the document is presented.

In this way, the lightweight document 1200 contains data that is sufficient to allow access to the remote video file 1230 when the lightweight document 1200 is ready to be displayed and presented. Until then, the page 1210 will contain only the video placeholder 1220 (namely the still image 1240 and the cloud metadata link 1250). People editing the lightweight document 1200 will see the still image 1240 and know that the lightweight document 1200 is properly prepared to present the video file 1230. The purpose of creating the lightweight document 1200 is to allow this document to be fully created with links to one or more (and perhaps many more) videos without the lightweight document 1200 becoming extremely large. This is especially important when the lightweight document 1200 is going to transmitted and shared with multiple recipients, each of whom may end up storing the lightweight document 1200 in their own local data storage and who, in turn, might share it with other recipients. With the lightweight document 1200, each of those recipients has a fully configured version of the lightweight document 1200 that can easily be edited without the lightweight document 1200 being bloated with numerous video files.

In many primary applications, the document is edited in an editing view and then presented in a presentation view. In editing view, the lightweight document 1200 is shown with the still image 1240 on the page 1210. When an individual wants to actually view the lightweight document 1200, they can request that the document 1200 be prepared and presented in presentation view. This presentation request is received at step 1320, and may be made by pushing an interface button, such as button 1260 shown in FIG. 12. Next, step 1325 accesses and downloads the video file 1230 by following the cloud metadata link 1250 in the video placeholder 1220. At step 1330, a copy of the video file 1285 is downloaded and stored in the temporary data 1270.

Next, step 1335 copies the lightweight document 1200 to the temporary data 1270 as the prepared document 1280. At step 1340, the video placeholder 1220 in the prepared document 1280 is replaced with an operable video link 1290 that links to the local video file 1285. Operable video links, such as link 1290, allow documents (such as PowerPoint documents or other graphical or presentation documents) to utilize an external video file as part of the document without requiring that the video file form part of the physical, saved document.

Step 1345 next causes the primary application 140 to present the prepared document 1280 that contains the operable video link 1290. The primary application 140 will be capable of following the operable video link 1290 during presentation to play the copy of the video file 1285. Note, in some embodiments the copy of the video file 1285 will be integrated and inserted directly within the page 1210 instead of using the operable video link 1290.

When the primary application 140 is no longer presenting the prepared document 1280 (which would be the case if the user escaped out of the presentation, or when the presentation is complete), step 1350 will identify this as the end of the presentation. At this point, step 1355 will delete the prepared document 1280 and the video file 1285 from the temporary data 1270. The method 1300 then ends at step 1360.

In this way, a user will see, examine, and edit the lightweight document 1200 through the primary application 140 and will not notice any difference from a fully functioning version of the document except that video file 1230 is represented by a still image 1240. However, whenever the user wishes to present the document, the video will be made available and be shown as part of the presented document. The user simply requests that this lightweight document 1200 be presented by the primary application 140, and steps 1320-1360 will function to seamlessly create the prepared document 1280, present the prepared document 1280 along with the video file 1285, and then automatically clean up after itself by removing the prepared document 1280 and the video file 1285 from the temporary data 1270 when the presentation is complete.

In some embodiments, the deletion of the video file 1285 does not occur immediately upon stopping the presentation (such as by escaping out of the presentation). Rather, these elements 1280, 1285 remain in the temporary file for a slightly longer period, such as until the user closes the lightweight document 1200 or shuts down the primary application 140 and plugin 142. This allows the user, for example, to edit the lightweight document 1200 and view the presentation multiple times in an editing session without requiring multiple downloads of the video file 1230 from the video accumulator data 162. After each edit of the lightweight document 1200, a new prepared document 1280 would need to be created once the prepare and present button 1260 is selected. Nonetheless, the existing copy of the video file 1285 can remain unchanged through the reviews of these multiple versions.

### Video Playlist Generation

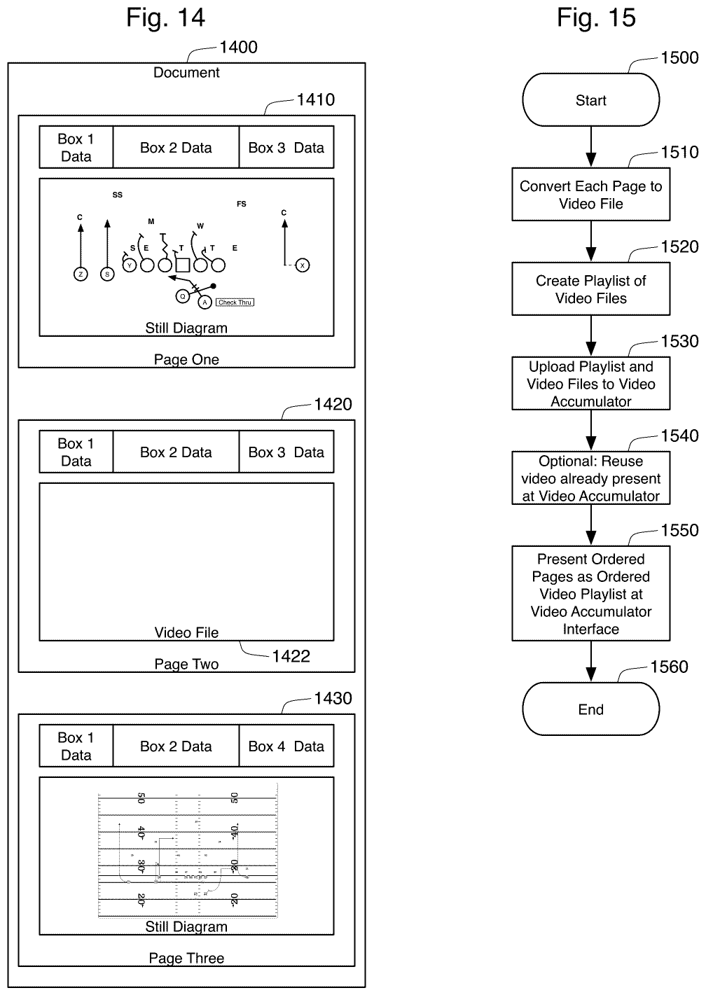

FIG. 14 shows a multiple page document 1400. The first page 1410 of the document 1400 contains a still diagram. The second page 1420 contains a video file 1422. In one embodiment, this video file 1422 originated in the video accumulator data 162 maintained by the video accumulator 160. As explained above in connection with FIGS. 12 and 13, the document 1400 may actually be constructed with a cloud metadata link 1250 to the video file 1422 stored in the video accumulator data 162. The document 1400 also contains a third page 1430, which also contains a still diagram.

FIG. 15 contains a flowchart outlining the steps for a method 1500 that creates a video playlist for document 1400. A video playlist can be useful when presenting the content of the document 1400 through an interface that is only capable of playing video files. In some instances, this type of video interface is utilized by video accumulator 160. As explained above, the system 10 is capable of creating document 1400 that can be edited and presented on the local computer 130 using primary application 140. However, if the user interface 270 is unable to present such a document 1400, it is not possible to send this document 1400 back to the video accumulator 160 for storage in the video accumulator data 162 for presentation through the user interface 270. Method 1500 corrects this deficiency.

The method 1500 begins at step 1510 with the conversion of each page 1410, 1420, 1430 of the document 1400 into a video file. Although page one 1410 and page three 1430 contain only static elements, a video file is created for that page. In effect, the video file for a static page is an unchanging video. Typically, such video files are of short duration, such as video files of five to ten seconds in length. A longer time duration is not needed, as any video interface would allow the pausing of the video when displaying these pages 1410, 1430. This pause can be of any duration desired by the user.

In one embodiment, the conversion of pages to video files at step 1510 occurs locally at local computer 130. The video conversion software can be incorporated into the plugin 142, or can be an application or operating system resource residing on the local computer 130. In other embodiments, the conversion occurs at the server operating as the video accumulator 160 on the network 120. This server provides a service that creates video files from static images or pages. In some embodiments, therefore, step 1510 creates a static page (such as a PDF) and submits the page to a service provided by the server of the video accumulator 160. The server would then store this video file in the video accumulator data 162 associated with the user.

The creation of a new video file for slide 1420 containing video file 1422 can also occur either locally or at the server of the video accumulator 160. The created new video file can show the data at the top of page two 1420 unchanging while the entire video of the video file 1422 plays out. Alternatively, the new video file of page two 1420 might consist only of the video file 1422 itself. In the latter embodiment, no conversion needs to occur at step 1510 for page two 1420.

At step 1520, a playlist of the video files is created. A playlist groups together numerous video files into an ordered list. When a playlist is “played,” the first video file in the playlist is played in its entirety, then the second video file is played, and so on through the list. In most environments, a user interface is provided when playing a playlist allowing pausing, reversing, and fast-forwarding. In some embodiments, the user interface provides a skip-forward function (skipping to the next video file in the playlist) and a skip-backwards function (returning to the previous video file in the playlist and/or the beginning of the currently played video file).

At step 1530, the playlist and the created video files are uploaded to the video accumulator 160 and stored in the video accumulator data 162 for the user. Of course, if the video accumulator 160 was responsible for creating the new video files for each page 1410, 1420, 1430 in step 1510, it would not be necessary to upload these video files. In this circumstance, step 1530 would simply upload the video playlist that creates an ordered list that identifies the new video files, with the video playlist reflecting the ordered pages 1410, 1420, 1430 of document 1400. At step 1540, it is noted that the video file 1422 for page two 1420 may already be stored in the video accumulator data 162 (as it may have originated there). As such, it may not be necessary to re-upload this video file 1422 as part of step 1530 even if the video files for the static pages 1410, 1430 are uploaded.

At step 1550, video files for each of the pages 1410, 1420, 1430 exist in the video accumulator data 162, and an ordered playlist has been created and uploaded to the video accumulator 160. Thus, step 1550 can simply play the uploaded playlist through the user interface 270 of the video accumulator 160. Method 1500 then ends at step 1560.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A method for creating documents comprising:
a) establishing a template defining a template slot for a content item;
b) using the template to generate a new document, the new document having a first slot and a second slot;
c) receiving a selection of a first content item for the first slot, the first content item being stored in a remote data store that is separate from client data;
d) ascertaining a first metadata identifier for the first content item;
e) confirming that no version of the first content item is stored in the client data by searching for the first metadata identifier in the client data;
f) downloading the first content item from the remote data store;
g) inserting the first content item into the first slot in the new document;
h) receiving a selection of a second content item for the second slot, the second content item being stored in the remote data store;
i) ascertaining a second metadata identifier for the second content item;
j) using the second metadata identifier to identify that an alternative version of the second content item is stored in the client data by searching for the second metadata identifier in the client data; and
k) inserting the alternative version of the second content item into the second slot in the new document.

2. The method of claim 1, wherein the first content item and the second content item are both video files.

3. The method of claim 1, further comprising:
l) receiving edits to the first content item that generate an edited version of the first content item; and
m) storing the edited version of the first content item in the client data along with the first metadata identifier.

4. The method of claim 3, further comprising:
n) using the template to generate a second document;
o) receiving a new selection of the first content item;
p) using the first metadata identifier to identify that the edited version of the first content item is stored in the client data by searching for the first metadata identifier in the client data; and
q) inserting the edited version of the first content item into the second document.

5. A method for creating documents comprising:
a) establishing a template defining a first template content box and a first template data box;
b) presenting a user interface to create a new document based on the template;
c) presenting in the user interface a first segment containing a selection list for a video accumulator, the video accumulator comprising a remote video server providing access to a plurality of video files associated with events, the events being associated with a plurality of data elements;
d) presenting, in the first segment, groupings based on the plurality of data elements;
e) receiving a group selection of a selected grouping in the first segment;
f) presenting in the user interface a second segment containing an event list identifying events that are consistent with the selected grouping;
g) receiving an event selection of a selected event in the second segment;
h) identifying a first video file for the selected event;
i) identifying a first data element for the selected event; and
j) creating a new page for the new document, the new page having a first page content box based on the first template content box and a first page data box based on the first template data box, the first page content box containing the first video file and the first page data box containing the first data element.

6. The method of claim 5, wherein the first video file is selected from among the plurality of video files.

7. The method of claim 6, wherein the template associates the first template content box with a first video type and wherein the first video file is associated with the first video type.

8. The method of claim 7, wherein the template defines a second template content box associated with a second video type, wherein a second video associated with the second video type is identified for the selected event from among the plurality of video files, and wherein the new page has a second page content box based on the second template content box that contains the second video.

9. The method of claim 8, wherein the template associates the first template data box with a first data type, wherein the first data element is associated with the first data type, and wherein the first data element is retrieved from a data accumulator accessed from a remote data server separate from the remote video server.

10. The method of claim 9, wherein the template defines a second template data box associated with a second data type, wherein a second data element associated with the second data type is identified for the selected event, wherein the second data element is not stored on the remote data server, and wherein the new page has a second page data box based on second template data box that contains the second data element.

11. The method of claim 5, wherein the first video file is selected from among local files not stored among the plurality of video files accessed by the remote video server.

12. The method of claim 11, wherein the first video file is identified by:
i) identifying a set of data elements associated with the selected event,
ii) searching the local files based on the set of data elements to identify a relevant subset of local files,
iii) presenting in the user interface the relevant subset of local files, and
iv) receiving through the user interface a selection of the first video file from the relevant subset of local files.

13. The method of claim 12, wherein the set of data elements is identified by presenting in the user interface a larger list of data elements associated with the selected event and receiving selection of a subset of the larger list of data elements.

14. The method of claim 13, wherein the event list is presented in a plurality of displayed columns, with each column displaying data associated with a particular data element, further wherein a user can select the plurality of displayed columns.

15. The method of claim 14, wherein the larger list of data elements comprises the particular data elements associated with the plurality of displayed columns.

16. A method for presenting a document in a primary application comprising:
a) receiving an identification of a remote video;
b) receiving an insertion request through the primary application to insert the remote video into the document;
c) inserting a video placeholder into the document, the video placeholding comprising:
i) a still image, and
ii) a link to the remote video;
d) displaying the document in an editing view including displaying the still image;
e) receiving a presentation request to present the document; and
f) after receiving the presentation request:
i) downloading a copy of the remote video,
ii) storing the copy of the remote video;
iii) modifying the document by replacing the video placeholder with data sufficient to play the copy of the remote video through the primary application, which creates a modified document;
iv) storing the modified document as a prepared document, and
v) presenting the prepared document through the primary application.

17. The method of claim 16, wherein the data sufficient to play the copy of the remote video is a local video link to the copy of the remote video.

18. The method of claim 16, wherein the data sufficient to play the copy of the remote video is comprises the copy of the remote video being embedded in the modified document.

19. The method of claim 16, wherein the prepared document and the copy of the remote video are stored in a temporary data location, further wherein the prepared document and the copy of the remote video are deleted from the temporary data location after presenting the prepared document through the primary application.

20. The method of claim 16, wherein the prepared document and the copy of the remote video are stored in a temporary data location, further wherein the prepared document and the copy of the remote video are deleted from the temporary data location when the primary application closes the document.
